(19) United States
(12) Patent Application Publication
(10) Pub. No.: US 2021/0203757 A1
(43) Pub. Date: Jul. 1, 2021

(54) METHOD AND APPARATUS FOR PROCESSING FRAME HEADER, AND COMMUNICATION DEVICE

(71) Applicant: GUANGDONG OPPO MOBILE TELECOMMUNICATIONS CORP., LTD., Dongguan (CN)

(72) Inventor: Qianxi LU, Dongguan (CN)

(21) Appl. No.: 17/203,517

(22) Filed: Mar. 16, 2021

Related U.S. Application Data
(63) Continuation of application No. PCT/CN2018/110514, filed on Oct. 16, 2018.

(51) Int. Cl. H04L 29/06; H04L 12/46

(52) U.S. Cl. CPC H04L 69/04; H04L 12/465; H04L 69/22

(57) ABSTRACT

Provided are a method and apparatus for processing a frame header, and a communication device. The method comprises: determining at least one of the following pieces of information corresponding to each information domain of an Ethernet frame header portion: type information, the type information being used for indicating that the information domain is static or indicating that the information domain is changing; a target policy, the target policy being used for indicating a transmission rule of the information domain; and an initialization format, the initialization format being used for initializing the information domain.

### CROSS-REFERENCE TO RELATED APPLICATIONS

The present application is a continuation application of International PCT Application No. PCT/CN2018/110514, having an international filing date of Oct. 16, 2018. The content of the above-identified application is hereby incorporated by reference.

### TECHNICAL FIELD

Implementations of the present application relate to the technical field of mobile communication, in particular to a method, apparatus for processing a frame header and a communication device.

### BACKGROUND

In a Long Term Evolution (LTE) system, the type of a Protocol Data Unit (PDU) session is IP type, but in a 5th Generation New Radio (NR) system, a PDU session supports not only an IP type but also an Ethernet type.

On the other hand, the Packet Data Convergence Protocol (PDCP) introduces header compression and decompression functions to support to use different header compression and decompression parameters for different Data Radio Bearers (DRB) according to a configured profile. The ROHC (Robust Header Compression) protocol is used for header compression in the PDCP. However, how to processing an Ethernet frame header in compression is a problem to be solved.

### SUMMARY

Implementations of the present application provide a method, apparatus for processing a frame header and a communication device.

A method for processing a frame header provided by an implementation of the present application includes: determining at least one piece of the following information corresponding to each information field of an Ethernet frame header: class information, used for indicating that the information field is STATIC or CHANGING; a target strategy, used for indicating a transmission rule of the information field; or an initialization format, used for initializing the information field.

An apparatus for processing a frame header provided by an implementation of the present application includes: a determining unit, configured to determine at least one piece of the following information corresponding to each information field of an Ethernet frame header: class information, used for indicating that the information field is STATIC or CHANGING; a target strategy, used for indicating a transmission rule of the information field; or an initialization format, used for initializing the information field.

A communication device provided by an implementation of the present application includes a processor and a memory. The memory is configured to store a computer program and the processor is configured to call and run the computer program stored in the memory to perform the above method for processing the frame header.

A chip provided by an implementation of the present application is configured to perform the above method for processing the frame header.

Specifically, the chip includes a processor configured to call and run a computer program from a memory to enable a device disposed with the chip to perform the above method for processing the frame header.

A computer readable storage medium provided by an implementation of the present application is configured to store a computer program to enable a computer to perform the above method for processing the frame header.

A computer program product provided by an implementation of the present application includes computer program instructions, and the computer program instructions enable a computer to perform the above method for processing the frame header.

When running on a computer, a computer program provided by an implementation of the present application enables a computer to perform the above method for processing the frame header.

With the technical solutions, a processing solution for various information fields in an Ethernet frame header is clarified, so that in the process of compressing the Ethernet frame header, the compression processing of the frame header can be realized efficiently and reasonably.

### BRIEF DESCRIPTION OF DRAWINGS

The drawings described herein are used to provide a further understanding of the present application and form a part of the present application. Illustrative examples of the present application and the description thereof are used to explain the present application and do not constitute improper limitation of the present application. In the drawings:

FIG. 1 is a schematic diagram of an architecture of a communication system provided by an implementation of the present application.

FIG. 2 is a schematic diagram of a protocol architecture among a UE, a 5G-AN and a core network.

FIG. 3 is a schematic flow chart of a method for processing a frame header provided by an implementation of the present application.

FIG. 4A is a frame format of an Ethernet II frame.

FIG. 4B is a frame format of an Ethernet 802.3 raw frame.

FIG. 4C is a frame format of an Ethernet 802.3 SAP frame.

FIG. 4D is a frame format of an Ethernet 802.3 SNAP frame.

FIG. 5 is a frame format of a VLAN frame using an IEEE 802.1Q standard.

FIG. 6 is a schematic diagram of a structure of an apparatus for processing a frame header provided by an implementation of the present application.

FIG. 7 is a schematic diagram of a structure of a communication device provided by an implementation of the present application.

FIG. 8 is a schematic diagram of a structure of a chip of an implementation of the present application.

FIG. 9 is a schematic block diagram of a communication system provided by an implementation of the present application.

FIG. 10 is an initialization format of an Ethernet II frame.

FIG. 11 is an initialization format of an Ethernet 802.3 SAP frame.

FIG. 12 is an initialization format of an Ethernet 802.3 SNAP frame.

FIG. 13 is an initialization format of a VLAN frame using an IEEE 802.1Q standard.

### DETAILED DESCRIPTION

The technical solutions in implementations of the present application will be described below with reference to the drawings in implementations of the present application. It is apparent that the implementations described are just some implementations of the present application, but not all implementations of the present application. According to the implementations of the present application, all other implementations achieved by a person of ordinary skill in the art without paying an inventive effort are within the protection scope of the present application.

The technical solutions of the implementations of the present application may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an LTE Frequency Division Duplex (FDD) system, an LTE Time Division Duplex (TDD) system, a Universal Mobile Telecommunication System (UMTS), a Worldwide Interoperability for Microwave Access (WiMAX) communication system, or a 5G system.

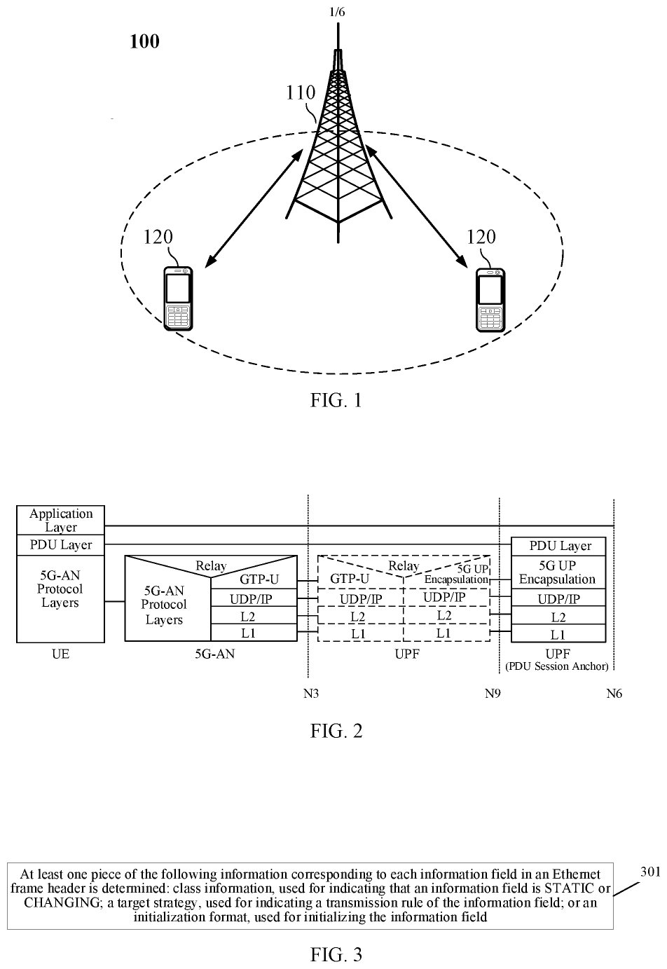

Illustratively, a communication system 100 applied in an implementation of the present application is shown in FIG. 1. The communication system 100 may include a network device 110, and the network device 110 may be a device that communicates with a terminal 120 (or referred to as a communication terminal, or a terminal device). The network device 110 may provide communication coverage for a specific geographical area, and may communicate with terminals located within the coverage area. Optionally, the network device 110 may be a Base Transceiver Station (BTS) in a GSM system or CDMA system, a NodeB (NB) in a WCDMA system, an Evolutional Node B (eNB or eNodeB) in an LTE system, or a radio controller in a Cloud Radio Access Network (CRAN), or the network device may be a network side device in a mobile switch center, a relay station, an access point, a vehicle-mounted device, a wearable device, a hub, a switch, a bridge, a router, or a network side device in a 5G network, or a network device in a future evolved Public Land Mobile Network (PLMN), etc.

The communication system 100 further includes at least one terminal 120 located within the coverage area of the network device 110. As used herein, the term “terminal” includes, but not limited to, a device configured to receive/send a communication signal via a wired circuit, for example, via a Public Switched Telephone Network (PSTN), a Digital Subscriber Line (DSL), a digital cable, a direct cable; and/or another data connection/network; and/or via a wireless interface, for instance, for a cellular network, a Wireless Local Area Network (WLAN), a digital television network such as a Digital Video Broadcasting-Handheld (DVB-H) network, a satellite network, or an AM-FM broadcast transmitter; and/or another terminal, and/or an Internet of Things (IoT) device. A terminal configured to communicate via a wireless interface may be referred to as a “wireless communication terminal”, a “wireless terminal” or a “mobile terminal”. Examples of the mobile terminal include, but not limited to, a satellite or cellular telephone, a Personal Communication System (PCS) terminal that can be combined with a cellular wireless telephone and data processing, faxing, and data communication abilities, a Personal Digital Assistant (PDA) that may include a radio telephone, a pager, an internet/intranet access, a Web browser, a memo pad, a calendar, and/or a Global Positioning System (GPS) receiver, and a conventional laptop and/or palmtop receiver or another electronic apparatus including a radio telephone transceiver. The terminal may be referred to an access terminal, User Equipment (UE), a subscriber unit, a subscriber station, a mobile station, a rover platform, a remote station, a remote terminal, a mobile device, a user terminal, a terminal, a wireless communication device, a user agent, or a user device. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device, or other processing device connected to a wireless modem, a vehicle-mounted device, a wearable device, a terminal in a 5G network, a terminal in a future evolved Public Land Mobile Network (PLMN), or the like.

Optionally, Device to Device (D2D) communication may be performed between the terminals 120.

Optionally, the 5G system or 5G network may be referred to as a New Radio (NR) system or a NR network.

FIG. 1 exemplifies one network device and two terminals. Optionally, the communication system 100 may include multiple network devices, and another quantity of terminals may be included within a coverage area of each network device, which is not limited in the implementations of the present application.

Optionally, the communication system 100 may include other network entities such as a network controller, and a mobile management entity, which is not limited in the implementations of the present application.

It should be understood that, a device with a communication function in a network/system in the implementation of the present application may be referred to as a communication device.

Taking the communication system 100 shown in FIG. 1 as an example, the communication device may include a network device 110 and a terminal 120 which have communication functions, and the network device 110 and the terminal 120 may be the specific devices described above, which will not be described here again. The communication devices may also include other devices in the communication system 100, such as a network controller, a mobile management entity, and other network entity, which is not limited in the implementations of the present application.

It should be understood that the terms “system” and “network” herein are often used interchangeably in this document. The term “and/or” in this document is merely an association relationship describing associated objects, indicating that there may be three relationships, for example, A and/or B may indicate three cases: A alone, A and B, and B alone. In addition, the symbol “/” in this document generally indicates that objects before and after the symbol “/” have an “or” relationship.

FIG. 2 is a schematic diagram of a protocol architecture among a UE, a 5G-AN (5G-Access Network), and a core network (specifically, a User Plane Function (UPF)). For a PDU layer, when the type of a PDU session is an IP type (for example, IPv4, IPv6, or IPv4v6), and data corresponding to the PDU session is IPv4 packets and/or IPv6 packets. When the type of the PDU session is an Ethernet type, data corresponding to the PDU session is an Ethernet frame. On the other hand, the PDCP layer in 5G-AN protocol layers has a function of header compression and decompression, to support to use different header compression and decompression parameters for different DRBs according to the configured profile.

FIG. 3 is a schematic flow chart of a method for processing a frame header provided by an implementation of the present application. As shown in FIG. 3, the method for processing the frame header includes the following act.

In act 301, at least one piece of the following information corresponding to each information field in an Ethernet frame header is determined: class information, used for indicating that an information field is STATIC or CHANGING; a target strategy, used for indicating a transmission rule of the information field; or an initialization format, used for initializing the information field.

In an implementation of the present application, the information corresponding to various information fields of the Ethernet frame header is determined by a protocol, and a terminal or a network side may determine the information corresponding to various information fields of the Ethernet frame header based on determination of the protocol.

In an implementation of the present application, the information corresponding to each information field in the Ethernet frame header includes at least one of the following: class information, used for indicating that the information field is STATIC or CHANGING; a target strategy (which may be called Header compression strategies), used for indicating a transmission rule of the information field; an initialization format, used for initializing the information field.

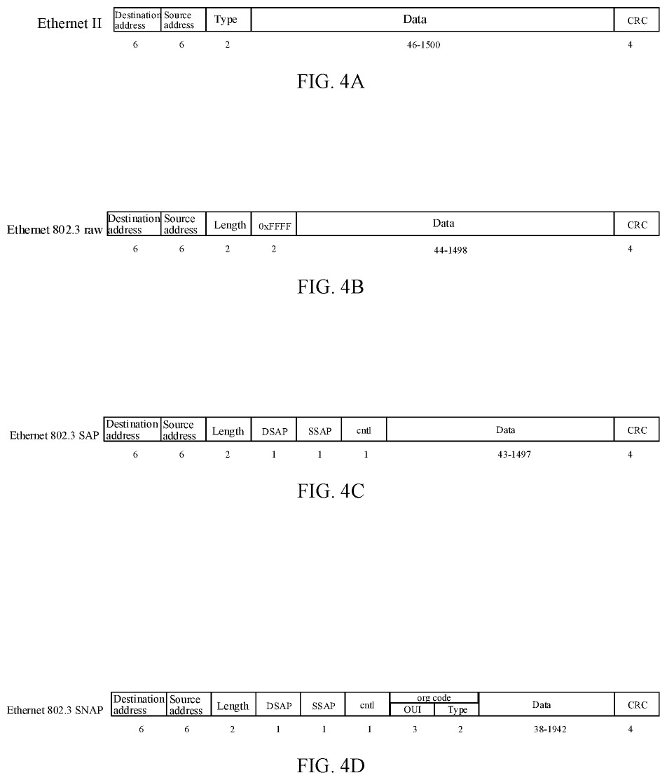

There are four types of Ethernet frames. Referring to FIG. 4A, FIG. 4A shows a frame format of an Ethernet II frame. Meanings of various information fields are shown in table 1 below.

TABLE 1

| Field | Length | Meaning |
|---|---|---|
| Destination | 6 octets | Destination MAC address |
| address | | |
| Source | 6 octets | Source MAC address |
| address | | |
| Type | 2 octets | Referring to protocol type |
| Data | 46~1500 | A minimum length of the data field must be 46 |
| | octets | octets to ensure that the frame length is at least 64 |
| | | octets, which means that a data field with 46 |
| | | octets must be used even if information with |
| | | one octet is transmitted. |
| | | If octets of the information filled in this field are |
| | | less than 46 octets, the rest of this field must be |
| | | padded. A maximum length of the data field is |
| | | 1500 octets. |
| CRC | 4 octets | Cyclic redundancy check (also called FCS or frame |
| | | check sequence) for errors of subsequent octets in |
| | | a frame |

Referring to FIG. 4B, the FIG. 4B is a frame format of an Ethernet 802.3 raw frame, wherein meanings of various information fields are shown in table 2 below.

TABLE 2

| Field | Length | Meaning |
|---|---|---|
| Destination | 6 octets | Destination MAC address |
| address | | |
| Source | 6 octets | Source MAC address |
| address | | |
| Length | 2 octets | Referring to octet length of subsequent data not |
| | | including the CRC code |
| 0xFFFF | 2 octets | Identifying the frame as a Novell Ethernet type frame |
| Data | 44~1498 | Load |
| | octets | |
| CRC | 4 octets | Cyclic redundancy check (also called FCS or |
| | | frame check sequence) for errors of subsequent |
| | | octets in a frame |

Referring to FIG. 4C, the FIG. 4C is a frame format of an Ethernet 802.3 SAP frame, wherein meanings of various information fields are shown in table 3 below.

TABLE 3

| Field | Length | Meaning |
|---|---|---|
| Destination | 6 octets | Destination MAC address |
| address | | |
| Source | 6 octets | Source MAC address |
| address | | |
| Length | 2 octets | Referring to octet length of subsequent data not |
| | | including the CRC code |
| DSAP | 1 octet | Destination service access point, if Type after the |
| | | DSAP is an IP frame, the value is set to 0x06. |
| SSAP | 1 octet | Source service access point, if Type after the SSAP |
| | | is an IP frame, the value is set to 0x06. |
| ctrl | 1 octet | Value of this field is usually set to 0x03, representing |
| | | an unnumbered IEEE 802.2 data format with a |
| | | connectionless service. |
| Data | 43~1497 | Load |
| | octets | |
| CRC | 4 octets | Cyclic redundancy check (also called FCS or frame |
| | | check sequence) for errors of subsequent octets in a |
| | | frame |

Referring to FIG. 4D, the FIG. 4D is a frame format of an Ethernet 802.3 SNAP frame, wherein meanings of various information fields are shown in table 4 below.

TABLE 4

| Field | Length | Meaning |
|---|---|---|
| Destination | 6 octets | Destination MAC address |
| address | | |
| Source | 6 octets | Source MAC address |
| address | | |
| Length | 2 octets | Referring to octet length of subsequent data not |
| | | including the CRC code |
| DSAP | 1 octet | Destination service access point, if Type after the |
| | | DSAP is an IP frame, the value is set to 0x06. |
| SSAP | 1 octet | Source service access point, if Type after the |
| | | SSAP is an IP frame, the value is set to 0x06. |
| ctrl | 1 octet | Value of this field is usually set to 0x03, representing |
| | | an unnumbered IEEE 802.2 data format with a |
| | | connectionless service. |
| SNAP-ID | 5 octets | Consisting of two parts, i.e., OUI and Type. |
| org cod | 3 octets | Organizationally unique identifier having 3 octets, |
| | | value of which usually equals to first 3 octets of the |
| | | MAC address, that is, a network adapter |
| | | manufacturer code. |
| Type | 2 octets | Identifying a type of upper layer data carried by the |
| | | Ethernet frame. |
| Data | 38~1492 | Load |
| | octets | |
| CRC | 4 octets | Cyclic redundancy check (also called FCS or frame |
| | | check sequence) for errors of subsequent octets in a |
| | | frame |

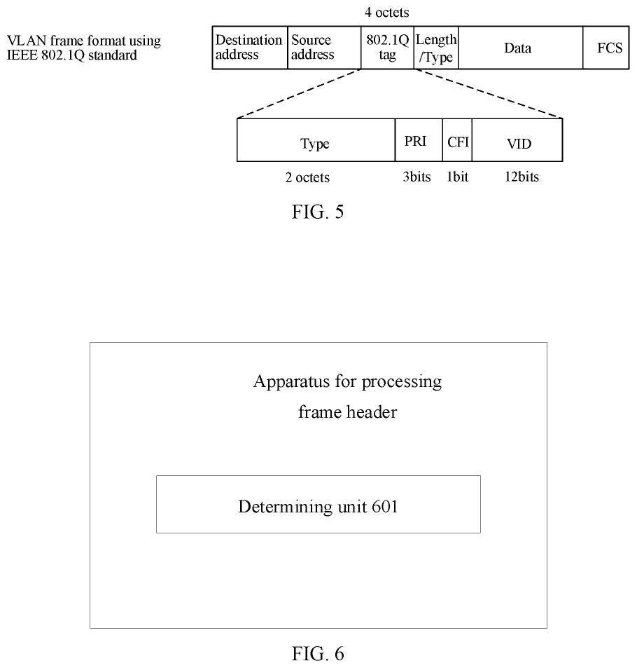

In the IEEE 802.1Q standard, the Ethernet frame format is modified, and a 4-octet 802.1Q tag is added between the source address field and the type field to form an 802.1Q Tag. Referring to FIG. 5, the FIG. 5 is a frame format of a VLAN frame using the IEEE 802.1Q standard, and the meanings of various information fields are shown in table 5 below.

TABLE 5

| Field | Length | Meaning |
|---|---|---|
| Destination | 6 octets | Destination MAC address |
| address | | |
| Source address | 6 octets | Source MAC address |
| 802.1Q tag | 4 octets | Consisting of Type, PRI, CFI and VID. |
| Type | 2 octets | Representing frame type. Value 0x8100 represents the 802.1Q |
| | | Tag frame. If a device that does not support 802.1Q receives |
| | | such a frame, the device will discard it. |
| PRI | 3 bits | Full name is Priority, it represents the priority of a frame, the |
| | | value range is 0~7, and the higher the value, the higher the |
| | | priority. Used for preferentially sending packets with a higher |
| | | priority when blocking occurs. |
| CFI | 1 bit | Full name is Canonical Format Indicator, and it represents |
| | | whether the MAC address is a canonical format. CFI being 0 |
| | | represents a canonical format, and CFI being 1 represents a |
| | | non-canonical format. Used for distinguishing Ethernet frame, |
| | | FDDI (fiber distributed digital interface) frame and token ring |
| | | frame. In Ethernet, the value of CFI is 0. |
| VID | 12 bit | Full name is VLAN ID, and it represents a VLAN to which |
| | | the frame belongs. In VRP, the value range of configurable |
| | | VLAN ID is 1 to 4094. 0 and 4095 are specified to be |
| | | reserved VLAN IDs in the protocol. |
| | | Three types: |
| | | Untagged frame: VID is Not Applicable (NA) |
| | | Priority-tagged frame: VID is 0x000 |
| | | VLAN-tagged frame: VID range is 0~4095 |
| | | Three special VIDs: |
| | | 0x000: priority is set but no VID |
| | | 0x001: default VID |
| | | 0xFFF: reserved VID |
| Length/Type | 2 octets | Referring to octet length of subsequent data not including the |
| | | CRC code |
| Data | 42~1500 | Load (may contain padding bits) |
| | octets | |
| CRC | 4 octets | Cyclic redundancy check (also called FCS or frame check |
| | | sequence) for errors of subsequent octets in a frame |

In the following, the technical solutions of the implementations of the present application are respectively illustrated through examples by combining Ethernet frames of different types.

### Example One

The type of the Ethernet frame is an Ethernet II frame, and a header of the Ethernet II frame includes the following information fields: a destination address field, a source address field and a type field.

The class information of the destination address field and the source address field is first class information, and the first class information is used for indicating that the information field is STATIC.

The target strategy of the destination address field and the source address field is a first strategy, and the first strategy is used for indicating that the information field is transmitted only initially, that is, the information field is transmitted at the beginning.

The class information of the type field is second class information, and the second class information is used for indicating that the information field is CHANGING.

The target strategy of the type field is a second strategy, and the second strategy is used for indicating that the information field is transmitted initially, but is prepared to update during transmission.

Further, the second class information has first subclass information, and the first subclass information is RARELY-CHANGING (RC) information.

In an actual implementation, various information fields in an Ethernet frame header is classified into three categories: Static part, Dynamic part and Eliminated part.

For example, referring to FIG. 4A, the details are as follows.

1. Static part: the destination address field and the source address field

Class information: STATIC (the first class information).

Target compression strategy (also called header compression strategy): Transmit only initially (the first strategy).

An initialization format of the destination address field and source address field is shown in FIG. 10.

Class information: CHANGING (the second class information), and subclass (the first subclass information) is RC (RARELY-CHANGING).

Target compression strategy (also called the header compression strategy): Transmit initially, but be prepared to update (the second strategy).

An initialization format of the Type field is shown in FIG. 10.

3. Eliminated part: none

It should be underlined that the Ethernet frame header works according to a header compression framework defined by the RFC protocol.

### Example Two

The type of an Ethernet frame is an Ethernet 802.3 SAP frame, and a header of the Ethernet 802.3 SAP frame includes the following information fields: a destination address field, a source address field, a length field, a destination service access point (DSAP) field, a source service access point (S SAP) field and a control (cntl) field.

The class information of the destination address field, the source address field, the length field, the DSAP field, the SSAP field and the cntl field is first class information, and the first class information is used for indicating that the information field is STATIC.

The target strategy of the destination address field, the source address field, the length field, the DSAP field, the SSAP field, and the cntl field is a first strategy, and the first strategy is used for indicating that the information field is transmitted only initially, that is, the information field is transmitted at the beginning.

Furthermore, if only a frame format of Ethernet 802.3 is supported and a frame format of Ethernet II is not supported for transmission in a system, then: the class information of the length field is third class information, and the third class information is INFERRED class information; the target strategy of the length field is a third strategy, and the third strategy is used for indicating that the information field does not need to be transmitted.

In an actual implementation, various information fields in the Ethernet frame header is classified into three categories: Static part, Dynamic part and Eliminated part.

For example, referring to FIG. 4C, the details are as follows.

1. Static part: the destination address field, the source address field, the length field, the DSAP field, the SSAP field and the cntl field

Class information: STATIC (the first class information).

Target compression strategy (also called header compression strategy): Transmit only initially (the first strategy).

Particularly, if the Ethernet II frame is not supported, the length field may be defined as INFERRED class (third class information), and a processing rule is Do not send at all (the third strategy).

An initialization format of the destination address field, source address field, length field, DSAP field, SSAP field and cntl field is shown in FIG. 11.

2. Dynamic part: none

3. Eliminated part: none

It should be underlined that the Ethernet frame header works according to a header compression framework defined by the RFC protocol.

### Example Three

The type of an Ethernet frame is an Ethernet 802.3 SNAP frame, and a header of the Ethernet 802.3 SNAP frame includes the following information fields: a destination address field, a source address field, a length field, a DSAP field, a SSAP field, a cntl field, and an organization code (org code) field.

The class information of the destination address field, the source address field and the length field is first class information, and the first class information is used for indicating that the information field is STATIC.

The target strategy of the destination address field, the source address field and the length field is a first strategy, and the first strategy is used for indicating that the information field is transmitted only initially, that is, the information field is transmitted at the beginning.

The class information of the type field is second class information, and the second class information is used for indicating that the information field is CHANGING.

The target strategy of the type field is a second strategy, and the second strategy is used for indicating that the information field is transmitted initially, but is prepared to update during transmission.

The class information of the DSAP field, the SSAP field, the cntl field and the org code field is fourth class information, and the fourth class information is used for indicating that the information field is STATIC-KNOWN.

The target strategy of the DSAP field, the SSAP field, the cntl field and the org code field is a third strategy, and the third strategy is used for indicating that the information field does not need to be transmitted.

Further, the second class information has first subclass information, and the first subclass information is RC information.

Furthermore, if only a frame format of Ethernet 802.3 is supported and a frame format of Ethernet II is not supported for transmission in a system, then:

the class information of the length field is third class information, and the third class information is INFERRED class information;

the target strategy of the length field is a third strategy, and the third strategy is used for indicating that the information field does not need to be transmitted.

In an actual implementation, various information fields in the Ethernet frame header is classified into three categories: Static part, Dynamic part and Eliminated part.

For example, referring to FIG. 4D, the details are as follows.

1. Static part: the destination address field, the source address field and the length field Class information: STATIC (the first class information).

Target compression strategy (also called header compression strategy): Transmit only initially (the first strategy).

Particularly, if the Ethernet II frame is not supported, the length field may be defined as INFERRED class (the third class information), and a processing rule is Do not send at all (the third strategy).

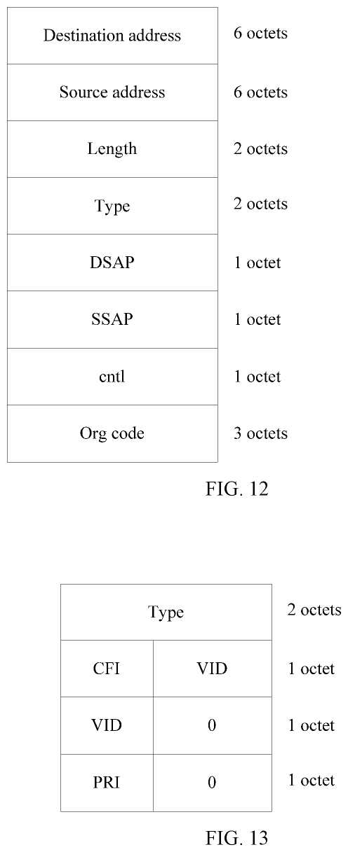

An initialization format of the destination address field, source address field and length field is shown in FIG. 12.

2. Dynamic part: Type field

Class information: CHANGING (the second class information), and subclass (first subclass information) is RARELY-CHANGING (RC).

Target compression strategy (also called the header compression strategy): Transmit initially, but be prepared to update (the second strategy).

An initialization format of the Type field is shown in FIG. 12.

3. Eliminated part: DSAP field, SSAP field, cntl field and org code field Class information: STATIC-KNOWN (the fourth class information) Target compression strategy (also called the header compression strategy): Do not send at all (the third strategy).

An initialization format of the SAP field, SSAP field, cntl field and org code field is shown in FIG. 12.

It should be underlined that the Ethernet frame header works according to a header compression framework defined by the RFC protocol.

### Example Four

The type of an Ethernet frame is a VLAN frame, and a header of the VLAN frame includes an 802.1Q tag including the following information fields: a type field, a PRI field, a CFI field and a VID field.

The class information of the type field, the CFI field and the VID field is first class information, and the first information is used for indicating that the information field is STATIC.

The target strategy of the type field, the CFI field and the VID field is a first strategy, and the first strategy is used for indicating the information field is transmitted only initially, that is, the information field is transmitted at the beginning.

The class information of the PM field is second class information, and the second class information is used for indicating that the information field is CHANGING.

The target strategy of the PM field is a fourth strategy, a fifth strategy or a sixth strategy, wherein the fourth strategy is used for indicating the information field is transmitted in all data packets, the fifth strategy is used for indicating the information field is prepared to update during transmission, and the sixth strategy is used for indicating the information field is transmitted frequently.

In an actual implementation, various information fields in the 802.1Q tag of a VLAN frame is classified into three categories: Static part, Dynamic part and Eliminated part.

For example, referring to FIG. 5, the details are as follows.

1. Static part: Type field, CFI field and VID field Class information: static (the first class information).

Target compression strategy (also called header compression strategy): Transmit only initially (the first strategy).

An initialization format of Type field, CFI field and VID field is shown in FIG. 13.

2. Dynamic part: PM field Class information: CHANGING (the second class information), and subclass (the first subclass information) is IRREGULAR or RARELY-CHANGING (RC).

Target compression strategy (also called header compression strategy): Transmit as-is in all packets (the fourth strategy) or Be prepared to update (the fifth strategy) or send as-is frequently (sixth strategy).

An initialization format of the PM field is shown in FIG. 13.

3. Eliminated part: none

It should be underlined that the Ethernet frame header works according to a header compression framework defined by the RFC protocol.

FIG. 6 is a schematic diagram of structure of an apparatus for processing a frame header provided by an implementation of the application. As shown in FIG. 6, the apparatus for processing the frame header includes:

a determining unit 601, configured to determine at least one piece of the following information corresponding to each information field of an Ethernet frame header: class information, used for indicating that the information field is STATIC or CHANGING; a target strategy, used for indicating a transmission rule of the information field; and an initialization format, used for initializing the information field.

In an implementation, at least one piece of the following information corresponding to each information field of an Ethernet frame header is determined:

class information, used for indicating that the information field is STATIC or CHANGING;

a target strategy, used for indicating a transmission rule of the information field; and

an initialization format, used for initializing the information field.

Further, the second class information has first subclass information, and the first subclass information is RC information.

In an implementation, the type of an Ethernet frame is an Ethernet 802.3 SAP frame, and a header of the Ethernet 802.3 SAP frame includes the following information fields: a destination address field, a source address field, a length field, a destination service access point (DSAP) field, a source service access point (SSAP) field and a control (cntl) field.

The class information of the destination address field, the source address field, the length field, the DSAP field, the SSAP field and the cntl field is first class information, and the first class information is used for indicating that the information field is STATIC.

The target strategy of the destination address field, the source address field, the length field, the DSAP field, the SSAP field, and the cntl field is a first strategy, and the first strategy is used for indicating that the information field is transmitted only initially, that is, the information field is transmitted at the beginning.

Furthermore, if only a frame format of Ethernet 802.3 is supported and a frame format of Ethernet II is not supported for transmission in a system, then:

the class information of the length field is third class information, and the third class information is INFERRED class information;

the target strategy of the length field is a third strategy, and the third strategy is used for indicating that the information field does not need to be transmitted.

In an implementation, the type of an Ethernet frame is an Ethernet 802.3 SNAP frame, and a header of the Ethernet 802.3 SNAP frame includes the following information fields: a destination address field, a source address field, a length field, a DSAP field, a SSAP field, a cntl field, and an organization code (org code) field.

The class information of the destination address field, the source address field and the length field is first class information, and the first class information is used for indicating that the information field is STATIC.

The target strategy of the destination address field, the source address field and the length field is a first strategy, and the first strategy is used for indicating that the information field is transmitted only initially, that is, the information field is transmitted at the beginning.

The class information of the type field is second class information, and the second class information is used for indicating that the information field is CHANGING.

The target strategy of the type field is a second strategy, and the second strategy is used for indicating that the information field is transmitted initially, but is prepared to update during transmission.

The class information of the DSAP field, the SSAP field, the cntl field and the org code field is fourth class information, and the fourth class information is used for indicating that the information field is STATIC-KNOWN.

The target strategy of the DSAP field, the SSAP field, the cntl field and the org code field is the third strategy, and the third strategy is used for indicating that the information field does not need to be transmitted.

Further, the second class information has first subclass information, and the first subclass information is RC information.

Furthermore, if only a frame format of Ethernet 802.3 is supported and a frame format of Ethernet II is not supported for transmission in a system, then:

class information of the length field is third class information, and the third class information is INFERRED class information; and

a target strategy of the length field is a third strategy, and the third strategy is used for indicating that the information field does not need to be transmitted.

In an implementation, the type of an Ethernet frame is a VLAN frame, and a header of the VLAN frame includes an 802.1Q tag including the following information fields: a type field, a PRI field, a CFI field and a VID field.

Class information of the type field, the CFI field and the VID field is first class information, and the first class information is used for indicating that the information field is STATIC.

A target strategy of the type field, the CFI field and the VID field is a first strategy, and the first strategy is used for indicating the information field is transmitted only initially, that is, the information field is transmitted at the beginning.

Class information of the PRI field is second class information, and the second class information is used for indicating that the information field is CHANGING.

A target strategy of the PRI field is a fourth strategy, a fifth strategy or a sixth strategy, wherein the fourth strategy is used for indicating the information field is transmitted in all data packets, the fifth strategy is used for indicating the information field is prepared to update during transmission, and the sixth strategy is used for indicating the information field is transmitted frequently.

Those skilled in the art should understand that the relevant description of the apparatus for processing the frame header in the implementation of the present application may be understood with reference to the relevant description of the method for processing the frame header in the implementation of the present application.

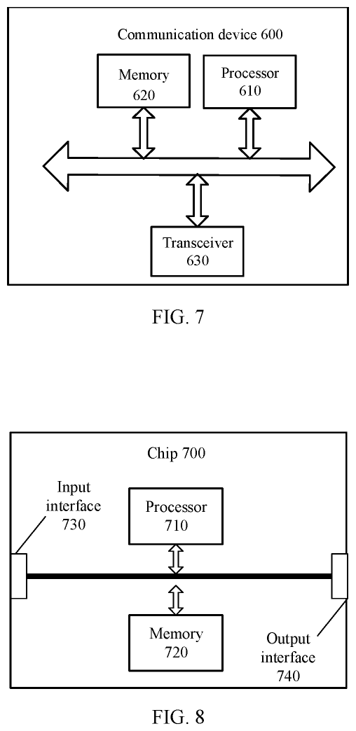

FIG. 7 is a schematic diagram of structure of a communication device 600 provided by an implementation of the present application. The communication device may be a terminal or a network device. The communication device 600 shown in FIG. 7 includes a processor 610, which may call and run a computer program from a memory to implement the methods in the implementations of the present application.

Optionally, as shown in FIG. 7, the communication device 600 may further include a memory 620, wherein the processor 610 may call and run a computer program from the memory 620 to implement the method in the implementation of the present application.

In the above, the memory 620 may be a separate device independent of the processor 610 or may be integrated in the processor 610.

Optionally, as shown in FIG. 7, the communication device 600 may further include a transceiver 630, and the processor 610 may control the transceiver 630 to communicate with other devices. Specifically, the transceiver 630 may send information or data to other devices or receive information or data sent by other devices.

The transceiver 630 may include a transmitter and a receiver. The transceiver 630 may further include antennas, and the number of antennas may be one or more.

Optionally, the communication device 600 may specifically be a network device of an implementation of the present application, and the communication device 600 may implement the corresponding processes implemented by the network device in various methods of the implementations of the present application, which will not be repeated here for brevity.

Optionally, the communication device 600 may be specifically a mobile terminal/terminal of an implementation of the present application, and the communication device 600 may implement the corresponding processes implemented by the mobile terminal/terminal in various methods of the implementations of the present application, which will not be repeated here for brevity.

FIG. 8 is a schematic diagram of structure of a chip 700 of an implementation of the present application. A chip 700 shown in FIG. 8 includes a processor 710, wherein the processor 710 may call and run a computer program from a memory to implement the method in the implementation of the present application.

Optionally, as shown in FIG. 8, the chip 700 may further include a memory 720, wherein the processor 710 may call and run a computer program from the memory 720 to implement the method in the implementation of the present application.

In the above, the memory 720 may be a separate device independent of the processor 710 or may be integrated in the processor 710.

Optionally, the chip 700 may further include an input interface 730, wherein the processor 710 may control the input interface 730 to communicate with other devices or chips. Specifically, the processor 710 may acquire information or data sent by other devices or chips.

Optionally, the chip 700 may further include an output interface 740, wherein the processor 710 may control the output interface 740 to communicate with other devices or chips. Specifically, the processor 710 may output information or data to other devices or chips.

Optionally, the chip may be applied in a network device of the implementation of the present application, and the chip may implement the corresponding processes implemented by the network device in various methods of the implementations of the present application, which will not be repeated here for brevity.

Optionally, the chip may be applied in a mobile terminal/terminal of the implementation of the present application, and the chip may implement the corresponding processes implemented by the mobile terminal/terminal in various methods of the implementations of the present application, which will not be repeated here for brevity.

It should be understood that the chip mentioned in the implementation of the present application may be referred to as a system-level chip, a system chip, a chip system or a system-on-chip, etc.

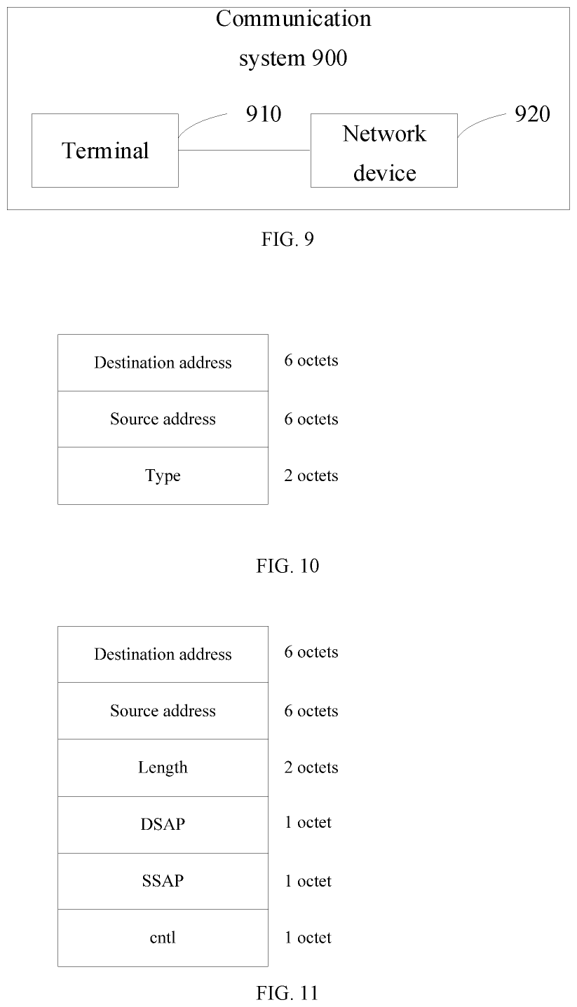

FIG. 9 is a schematic block diagram of a communication system 900 provided by an implementation of the present application. As shown in FIG. 9, the communication system 900 may include a terminal 910 and a network device 920.

In the above, the terminal 910 may be configured to implement the corresponding functions implemented by the terminal in the above-mentioned method, and the network device 920 may be configured to implement the corresponding functions implemented by the network device in the above-mentioned method, which will not be repeated here for brevity.

It should be understood that, the processor in the implementation of the present application may be an integrated circuit chip having a signal processing capability. In an implementation process, the acts of the foregoing method implementations may be implemented by using an integrated logic circuit of hardware in the processor or instructions in a form of software. The processor may be a general purpose processor, a Digital Signal Processor (DSP), an Application Specific Integrated Circuit (ASIC), a Field Programmable Gate Array (FPGA) or another programmable logic device, a discrete gate or a transistor logic device, or a discrete hardware component. The processor may implement or perform methods, steps and logical block diagrams disclosed in the implementation of the present application. The general purpose processor may be a microprocessor, or the processor may be any conventional processor or the like. The acts of the method disclosed with reference to the implementation of the present application may be directly implemented by a hardware decoding processor, or may be implemented by a combination of hardware and software modules in the decoding processor. The software modules may be located in a storage medium commonly used in the art, such as a random access memory, a flash memory, a read-only memory, a programmable read-only memory or an electrically erasable programmable memory, or a register. The storage medium is located in the memory, and the processor reads the information in the memory and completes the acts of the above method in combination with its hardware.

It may be understood that, the memory in the implementation of the present application may be a volatile memory or a non-volatile memory, or may include both a volatile memory and a non-volatile memory. The non-volatile memory may be a Read-Only Memory (ROM), a

Programmable ROM (PROM), an Electrically EPROM (EPROM), an electrically erasable programmable read-only memory (EEPROM), or a flash memory. The volatile memory may be a Random Access Memory(RAM), and is used as an external cache. Through exemplary but not limitative description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a s Synchlink DRAM (SLDRAM), and a Direct Rambus RAM (DR RAM). It should be noted that the memories in the systems and methods described in this specification are intended to include, but are not limited to, these and any other suitable types of memories.

It should be understood that, the foregoing memory is an example for illustration and should not be construed as limiting. For example, optionally, the memory in the implementations of the present application may further be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), a Direct Rambus RAM (DR RAM), or the like. That is, memories in the implementations of the present application are intended to include, but are not limited to, these and any other suitable types of memories.

An implementation of the present application further provides a computer readable storage medium, configured to store a computer program.

Optionally, the computer-readable storage medium may be applied in a network device of the implementation of the present application, and the computer program enables the computer to perform the corresponding processes implemented by the network device in various methods of the implementations of the present application, which will not be repeated here for brevity.

Optionally, the computer-readable storage medium may be applied in a mobile terminal/terminal of the implementation of the present application, and the computer program enables the computer to perform the corresponding processes implemented by the mobile terminal/terminal in various methods of the implementations of the present application, which will not be repeated here for brevity.

An implementation of the present application further provides a computer program product, including computer program instructions.

Optionally, the computer program product may be applied in a network device of the implementation of the present application, and the computer program instructions enable the computer to perform the corresponding processes implemented by the network device in various methods of the implementations of the present application, which will not be repeated here for brevity.

Optionally, the computer program product may be applied in a mobile terminal/terminal of the implementation of the present application, and the computer program instructions enable the computer to perform the corresponding processes implemented by the mobile terminal/terminal in various methods according to the implementations of the present application, which will not be repeated here for brevity.

An implementation of the present application further provides a computer program.

Optionally, the computer program may be applied in a network device of the implementation of the present application. When the computer program is run on the computer, the computer is enabled to perform the corresponding processes implemented by the network device in various methods of the implementation of the present application, which will not be repeated here for brevity.

Optionally, the computer program may be applied in a mobile terminal/terminal of the implementation of the present application. When the computer program is run on the computer, the computer is enabled to perform the corresponding processes implemented by the mobile terminal/terminal in various methods of the implementation of the present application, which will not be repeated here for brevity.

Those of ordinary skill in the art will recognize that the exemplary units and algorithm acts described in combination with the implementations disclosed herein may be implemented in electronic hardware, or a combination of computer software and electronic hardware. Whether these functions are implemented in hardware or software depends on the specific application and design constraints of the technical solution. Those skilled in the art may use different methods to implement the described functions in respect to each particular application, but such implementation should not be considered to be beyond the scope of the present application.

Those skilled in the art may clearly understand that for convenience and conciseness of description, the specific working processes of the systems, apparatuses and units described above may refer to the corresponding processes in the method implementations and will not be described here.

In several implementations provided by the present application, it should be understood that the disclosed systems, apparatuses and methods may be implemented in other ways. For example, the apparatus implementations described above are only illustrative, for example, the division of the units is only a logical function division, and there may be other division manners in actual implementation, for example, multiple units or components may be combined or integrated into another system, or some features may be ignored or not executed. On the other hand, the mutual coupling or direct coupling or communication connection shown or discussed may be indirect coupling or communication connection through some interface, apparatus or unit, and may be in electrical, mechanical or other forms.

The unit described as a separate component may or may not be physically separated, and the component shown as a unit may or may not be a physical unit, i.e., it may be located in one place or may be distributed over multiple network units. Some or all of the units may be selected according to actual needs to achieve the purpose of the implementations.

In addition, various functional units in various implementations of the present application may be integrated in one processing unit, or the various units may be physically present separately, or two or more units may be integrated in one unit.

The functions may be stored in a computer readable storage medium if realized in a form of software functional units and sold or used as a separate product. Based on this understanding, the technical solution of the present application, in essence, or the part contributing to the prior art, or the part of the technical solution, may be embodied in the form of a software product stored in a storage medium, including a number of instructions for causing a computer device (which may be a personal computer, a server, or a network device and the like) to perform all or part of the acts of the method described in various implementations of the present application.

The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

What are described above are merely exemplary implementations of the present application, but the protection scope of the present application is not limited thereto. Any variation or substitution that may be easily conceived by a person skilled in the art within the technical scope disclosed by the present application shall be included within the protection scope of the present application. Therefore, the protection scope of the present application shall be determined by the protection scope of the claims.

What we claim is:

1. A method for processing a frame header, comprising:
determining at least one piece of the following information corresponding to each information field of an Ethernet frame header:
class information, used for indicating that the information field is STATIC or CHANGING;
a target strategy, used for indicating a transmission rule of the information field; or
an initialization format, used for initializing the information field.

2. The method of claim 1, wherein a type of an Ethernet frame is an Ethernet II frame, and a header of the Ethernet II frame comprises the following information fields: a destination address field, a source address field, and a type field; wherein
the class information of the destination address field and the source address field is first class information, wherein the first class information is used for indicating that the information field is STATIC;
the target strategy of the destination address field and the source address field is a first strategy, wherein the first strategy is used for indicating that the information field is transmitted only initially;
the class information of the type field is second class information, wherein the second class information is used for indicating that the information field is CHANGING; and
the target strategy of the type field is a second strategy, wherein the second strategy is used for indicating that the information field is transmitted initially, and is prepared to update during the transmission.

3. The method of claim 2, wherein the second class information has first subclass information, and the first subclass information is RARELY-CHANGING (RC) information.

4. The method of claim 1, wherein a type of an Ethernet frame is an Ethernet 802.3 SAP frame, and a header of the Ethernet 802.3 SAP frame comprises the following information fields: a destination address field, a source address field, a length field, a destination service access point (DSAP) field, a source service access point (SSAP) field and a control (cntl) field; wherein
the class information of the destination address field, the source address field, the length field, the DSAP field, the SSAP field and the cntl field is first class information, wherein the first class information is used for indicating that the information field is STATIC; and
the target strategy of the destination address field, the source address field, the length field, the DSAP field, the SSAP field, and the cntl field is a first strategy, wherein the first strategy is used for indicating that the information field is transmitted only initially.

5. The method of claim 4, wherein if only a frame format of Ethernet 802.3 is supported and a frame format of Ethernet II is not supported for transmission in a system, then:
the class information of the length field is third class information, wherein the third class information is INFERRED class information; and
the target strategy of the length field is a third strategy, wherein the third strategy is used for indicating that the information field does not need to be transmitted.

6. The method of claim 1, wherein a type of an Ethernet frame is an Ethernet 802.3 SNAP frame, and a header of the Ethernet 802.3 SNAP frame comprises the following information fields: a destination address field, a source address field, a length field, a destination service access point (DSAP) field, a source service access point (SSAP) field, a control (cntl) field, and an organization code (org code) field; wherein
the class information of the destination address field, the source address field and the length field is first class information, wherein the first class information is used for indicating that the information field is STATIC;
the target strategy of the destination address field, the source address field and the length field is a first strategy, wherein the first strategy is used for indicating that the information field is transmitted only initially;
the class information of the type field is second class information, wherein the second class information is used for indicating that the information field is CHANGING;
the target strategy of the type field is a second strategy, wherein the second strategy is used for indicating that the information field is transmitted initially, and is prepared to update during the transmission;
the class information of the DSAP field, the SSAP field, the cntl field and the org code field is fourth class information, wherein the fourth class information is used for indicating that the information field is STATIC-KNOWN; and
the target strategy of the DSAP field, the SSAP field, the cntl field and the org code field is a third strategy, wherein the third strategy is used for indicating that the information field does not need to be transmitted.

7. The method of claim 6, wherein the second class information has first subclass information, wherein the first subclass information is RARELY-CHANGING (RC) information.

8. The method of claim 6, wherein if only a frame format of Ethernet 802.3 is supported and a frame format of Ethernet II is not supported for transmission in a system, then:
the class information of the length field is third class information, wherein the third class information is INFERRED class information; and
the target strategy of the length field is the third strategy, wherein the third strategy is used for indicating that the information field does not need to be transmitted.

9. The method of claim 1, wherein a type of an Ethernet frame is a VLAN frame, and a header of the VLAN frame comprises an 802.1Q tag, the 802.1Q tag comprises the following information fields: a type field, a PRI field, a CFI field and a VID field; wherein
the class information of the type field, the CFI field and the VID field is first class information, wherein the first class information is used for indicating that the information field is STATIC;
the target strategy of the type field, the CFI field and the VID field is a first strategy, wherein the first strategy is used for indicating the information field is transmitted only initially;
the class information of the PM field is second class information, wherein the second class information is used for indicating that the information field is CHANGING; and
the target strategy of the PM field is a fourth strategy, a fifth strategy, or a sixth strategy, wherein the fourth strategy is used for indicating the information field is transmitted in all data packets, the fifth strategy is used for indicating the information field is prepared to update during the transmission, and the sixth strategy is used for indicating the information field is transmitted frequently.

10. An apparatus for processing a frame header, comprising a memory and a processor, wherein the processor is configured to execute instructions stored in the memory to perform following operation:
determining at least one piece of the following information corresponding to each information field of an Ethernet frame header:
class information, used for indicating that the information field is STATIC or CHANGING;
a target strategy, used for indicating a transmission rule of the information field; or
an initialization format, used for initializing the information field.

11. The apparatus of claim 10, wherein the information corresponding to each information field in the Ethernet frame header comprises at least one of the following:
the class information, used for indicating that the information field is STATIC or CHANGING;
the target strategy, used for indicating a transmission rule of the information field; and
the initialization format, used for initializing the information field.

12. The apparatus of claim 11, wherein the second class information has first subclass information, wherein the first subclass information is RARELY-CHANGING (RC) information.

13. The apparatus of claim 10, wherein a type of an Ethernet frame is an Ethernet 802.3 SAP frame, and a header of the Ethernet 802.3 SAP frame comprises the following information fields: a destination address field, a source address field, a length field, a destination service access point (DSAP) field, a source service access point (SSAP) field and a control (cntl) field; wherein
the class information of the destination address field, the source address field, the length field, the DSAP field, the SSAP field and the cntl field is first class information, wherein the first class information is used for indicating that the information field is STATIC; and
the target strategy of the destination address field, the source address field, the length field, the DSAP field, the SSAP field, and the cntl field is a first strategy, wherein the first strategy is used for indicating that the information field is transmitted only initially.

14. The apparatus of claim 13, wherein if only a frame format of Ethernet 802.3 is supported and a frame format of Ethernet II is not supported for transmission in a system, then:
the class information of the length field is third class information, wherein the third class information is INFERRED class information;
the target strategy of the length field is a third strategy, wherein the third strategy is used for indicating that the information field does not need to be transmitted.

15. The apparatus of claim 10, wherein a type of an Ethernet frame is an Ethernet 802.3 SNAP frame, and a header of the Ethernet 802.3 SNAP frame comprises the following information fields: a destination address field, a source address field, a length field, a destination service access point (DSAP) field, a source service access point (SSAP) field, a control (cntl) field, and an organization code(org code) field; wherein
the class information of the destination address field, the source address field and the length field is first class information, wherein the class information is used for indicating that the information field is STATIC;
the target strategy of the destination address field, the source address field and the length field is a first strategy, wherein the first strategy is used for indicating that the information field is transmitted only initially;
the class information of the type field is second class information, wherein the second class information is used for indicating that the information field is CHANGING;
the target strategy of the type field is a second strategy, wherein the second strategy is used for indicating that the information field is transmitted initially, and is prepared to update during the transmission;
the class information of the DSAP field, the SSAP field, the cntl field and the org code field is fourth class information, wherein the fourth class information is used for indicating that the information field is STATIC-KNOWN; and
the target strategy of the DSAP field, the SSAP field, the cntl field and the org code field is a third strategy, wherein the third strategy is used for indicating that the information field does not need to be transmitted.

16. The apparatus of claim 15, wherein the second class information has first subclass information, wherein the first subclass information is RARELY-CHANGING (RC) information.

17. The apparatus of claim 15, wherein if only a frame format of Ethernet 802.3 is supported and a frame format of Ethernet II is not supported for transmission in a system, then:
the class information of the length field is third class information, wherein the third class information is INFERRED class information; and
the target strategy of the length field is the third strategy, wherein the third strategy is used for indicating that the information field does not need to be transmitted.

18. The apparatus of claim 10, wherein a type of an Ethernet frame is a VLAN frame, and a header of the VLAN frame comprises an 802.1Q tag, the 802.1Q tag comprises the following information fields: a type field, a PRI field, a CFI field and a VID field; wherein
the class information of the type field, the CFI field and the VID field is first class information, wherein the first class information is used for indicating that the information field is STATIC;
the target strategy of the type field, the CFI field and the VID field is a first strategy, wherein the first strategy is used for indicating the information field is transmitted only initially;
the class information of the PRI field is second class information, wherein the second class information is used for indicating that the information field is CHANGING; and
the target strategy of the PM field is a fourth strategy, a fifth strategy, or a sixth strategy, wherein the fourth strategy is used for indicating the information field is transmitted in all data packets, the fifth strategy is used for indicating the information field is prepared to update during the transmission, and the sixth strategy is used for indicating the information field is transmitted frequently.

19. A communication device, comprising a processor and a memory, wherein the memory is configured to store a computer program, and the processor is configured to call and run the computer program stored in the memory to perform the method of claim 1.

20. A chip comprising: a processor configured to call and run a computer program from a memory to enable a device disposed with the chip to perform the method of claim 1.
